(19) United States
(12) Patent Application Publication
(10) Pub. No.: US 2015/0054843 A1
(43) Pub. Date: Feb. 26, 2015

(54) COLOR-CORRECT ALPHA BLENDING TEXTURE FILTER AND METHOD OF USE THEREOF

(71) Applicant: Nvidia Corporation, Santa Clara, CA (US)

(72) Inventors: John McDonald, Austin, TX (US); Cass Everitt, Austin, TX (US)

(73) Assignee: Nvidia Corporation, Santa Clara, CA (US)

(21) Appl. No.: 13/971,246

(22) Filed: Aug. 20, 2013

(51) Int. Cl. G06T 15/04

(52) U.S. Cl. CPC G06T 15/04
USPC 345/582

(57) ABSTRACT

A color-correct alpha blending texture filter and a method of texture filtering. One embodiment of the color-correct alpha blending texture filter includes: (1) an alpha blender configured to receive a post-multiplied pixel color and convert to a pre-multiplied pixel color, and (2) a filter configured to apply texture filtering to the plurality of pixels based on pre-multiplied pixel colors.

### TECHNICAL FIELD

This application is directed, in general, to alpha blending and, more specifically, to preserving the precision available in post-multiplied alpha blending while using pre-multiplied alpha blending.

### BACKGROUND

Many computer graphic images are created by mathematically modeling the interaction of light with a three dimensional scene from a given viewpoint. This process, called “rendering,” generates a two-dimensional image of the scene from the given viewpoint, and is analogous to taking a photograph of a real-world scene.

As the demand for computer graphics, and in particular for real-time computer graphics, has increased, computer systems with graphics processing subsystems adapted to accelerate the rendering process have become widespread. In these computer systems, the rendering process is divided between a computer's general purpose central processing unit (CPU) and the graphics processing subsystem, architecturally centered about a graphics processing unit (GPU). Typically, the CPU performs high-level operations, such as determining the position, motion, and collision of objects in a given scene. From these high level operations, the CPU generates a set of rendering commands and data defining the desired rendered image or images. For example, rendering commands and data can define scene geometry, lighting, shading, texturing, motion and camera parameters for a scene. The graphics processing subsystem creates one or more rendered images from the set of rendering commands and data.

Scene geometry is typically represented by geometric primitives, such as points, lines, polygons (for example, triangles and quadrilaterals), and curved surfaces, defined by one or more two- or three-dimensional vertices. Each vertex may have additional scalar or vector attributes used to determine qualities such as the color, transparency, lighting, shading, and animation of the vertex and its associated geometric primitives.

Many graphics processing subsystems are highly programmable through an application programming interface (API), enabling complicated lighting and shading algorithms, among other things, to be implemented. To exploit this programmability, applications can include one or more graphics processing subsystem programs, which are executed by the graphics processing subsystem in parallel with a main program executed by the CPU. Although not confined merely to implementing shading and lighting algorithms, these graphics processing subsystem programs are often referred to as “shading programs,” “programmable shaders,” or simply “shaders.”

Depending on the application and particular GPU, some processes are carried out on specialized modules or units within the GPU. These processes are often implemented in hardware to reduce respective latency. In non-real-time applications or as processing bandwidth becomes more abundant in newer GPUs, processes that would otherwise be implemented in hardware can be implemented in software as programmable shaders.

### SUMMARY

One aspect provides a texture filter operable to process a plurality of pixels having respective pixel colors. In one embodiment, the texture filter includes: (1) an alpha blender configured to receive a post-multiplied pixel color and convert to a pre-multiplied pixel color, and (2) a filter configured to apply texture filtering to the plurality of pixels based on pre-multiplied pixel colors.

Another aspect provides a method of texture filtering a plurality of pixels having respective pixel colors. In one embodiment, the method includes: (1) converting the respective pixel colors from post-multiplied format to pre-multiplied format, (2) filtering the plurality of pixels based on pre-multiplied pixel colors, and (3) returning filtered pre-multiplied pixel colors to post-multiplied format.

Yet another aspect provides a graphics processing subsystem. In one embodiment, the subsystem includes: (1) a memory coupled to a data bus and configured to store color and an alpha value as a post-multiplied tuple having red, green, blue and alpha components for a plurality of pixels, and (2) a processor coupled to the data bus and having a texture filtering unit configured to (2a) retrieve respective post-multiplied tuples for the plurality of pixels via the data bus, (2b) apply alpha blending to the respective post-multiplied tuples, (2c) employ alpha blended tuples to carry out texture filtering on the plurality of pixels, (2d) compute respective new pre-multiplied tuples for the plurality of pixels, and (2e) write the respective new pre-multiplied tuples in post-multiplied format to the memory via the data bus.

### BRIEF DESCRIPTION

Reference is now made to the following descriptions taken in conjunction with the accompanying drawings, in which:

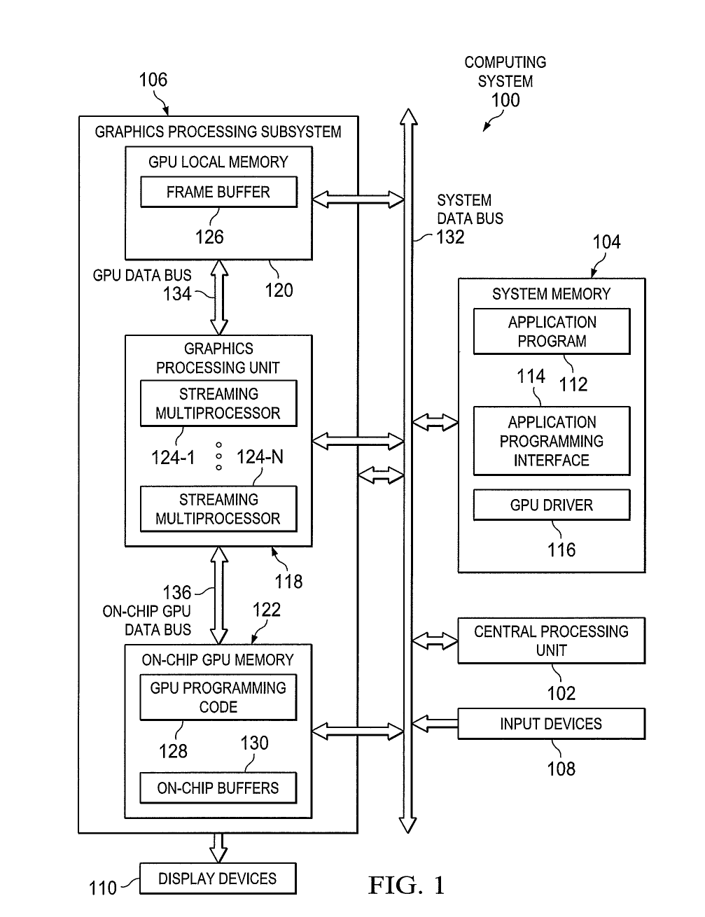

FIG. 1 is a block diagram of one embodiment of a computing system in which one or more aspects of the invention may be implemented;

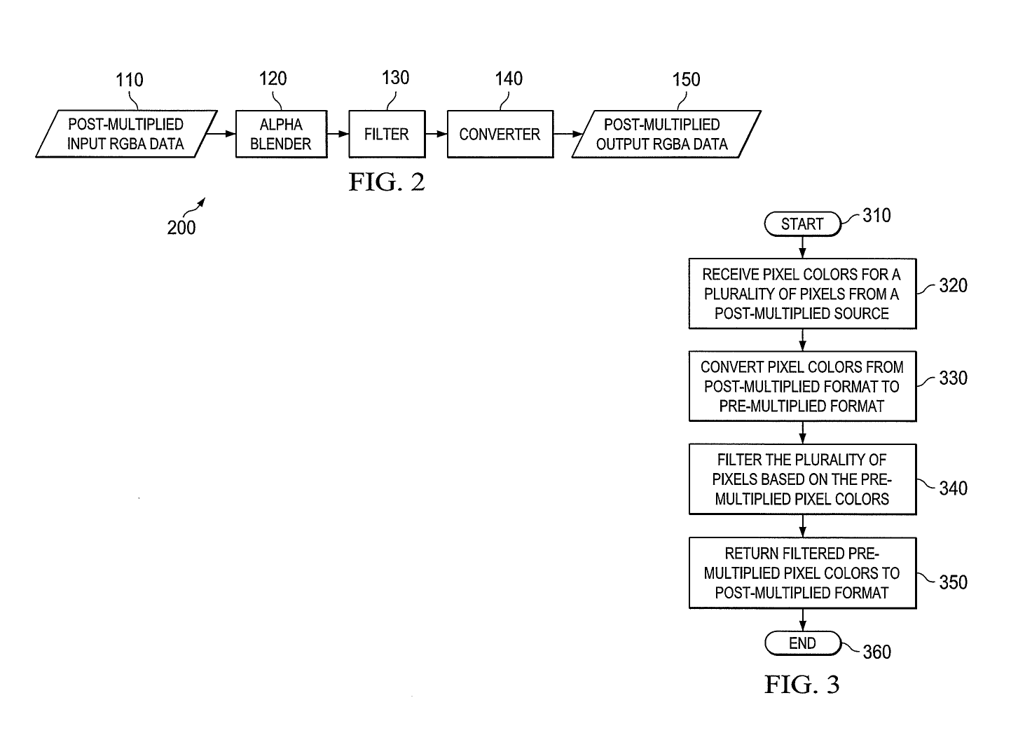

FIG. 2 is a block diagram of one embodiment of a texture filter; and

FIG. 3 is a flow diagram of one embodiment of a method of texture filtering.

### DETAILED DESCRIPTION

RGB is the designation for an additive color model in which a given color is represented as a combination of red, green and blue (RGB) light. Red, green and blue are considered components of the given color and can each have an independent intensity. The lowest intensity, typically zero, represents the darkest color, and the highest intensity represents the brightest. The RGB color model was originally developed as a model for human perception of color. In electronic systems, the RGB color model is used in capturing images, as in video cameras, scanners and digital cameras, and displaying images, as in televisions, computer displays, mobile phone displays and projectors. In some systems, the red, green and blue components are in a different order; for instance, blue-green-red (BGR) is a common re-ordering.

As an image is rendered into pixels, an RGB color value is determined for each pixel, represented by three numeric values that describe the intensity for the three components. For example, some systems use three eight-bit values for the red, green and blue components. Component color values are generally expressed as numbers from zero to one, one being the most intense. Component color values are sometimes expressed in un-normalized terms. For example, an eight-bit component color value would fall in the range from 1 to 256. Other systems may use greater precision, i.e., more bits; or less precision, i.e., fewer bits.

Many modern systems supplement the RGB color model with an additional data channel, known as the alpha channel. This is known as the RGBA color model. The alpha channel is an additional numeric value that typically specifies the opacity of the color. Although, some systems augment the alpha channel such that it can be used simply as an auxiliary data channel. The alpha value is generally expressed as a value from zero to one, one being completely opaque, but may also be expressed in un-normalized terms to match the color scale. Each pixel in an image would then, according to the RGBA color model, have a color expressed in an RGBA tuple. For example, the color for a 75% opaque, full-intensity red pixel could be represented by the following tuple:
(1.0,0.0,0.0,0.75), and the color for a 25% opaque, half-intensity blue pixel could be represented by the following tuple:
(0.0,0.0,0.5,0.25).

Opacity of a pixel having an RGB color is applied by a process known as alpha blending, which is sometimes referred to as alpha compositing. An RGBA pixel can only exhibit transparency when matted against a background color. The RGBA color, when not completely opaque, would then cast a certain hue over the background. The process of combining a pixel's color with a background color is alpha blending. There are two general techniques for alpha blending a pixel: post-multiplied alpha and pre-multiplied alpha. “Post-multiplied” and “pre-multiplied” each refer to the point in time in a rendering pipeline at which the alpha value is applied. Both techniques involve weighting component color values by the alpha value, which is to essentially multiply the alpha value by each of the three component color values. For example, applying an alpha of 0.5 (50% opaque) to the tuple:
(0.8,0.6,0.4,α) yields the following pre-multiplied tuple:
(0.4,0.3,0.2,0.5).
   The same color can also be represented as a post-multiplied tuple:
(0.8,0.6,0.4,0.5).

The post-multiplied and pre-multiplied alpha techniques each have their flaws under certain circumstances. Most notably, post-multiplied alpha blending can result in incorrect colors when used in combination with texture filtering. When a texture is applied to an image, the texels of the texture are mapped to the pixels of the image, according to a programmable shader or some texture mapping hardware module. With texture filtering, when a texture is sampled, neighboring texels are blended together and return a weighted average, which creates a “blurring” or “smoothing” effect. When post-multiplied alpha blending is used with texture filtering, the texture filtering blends improperly weighted colors, resulting in incorrect alpha blended colors.

With pre-multiplied alpha blending, a common complaint is the inherent loss of precision in the pre-multiplied representation. This is most often found in systems with limited memory and latency restrictions. For example, in real-time rendering a limited number of bits are available to represent each color component. That precision is often reduced further if any form of compression is used. When each color component is multiplied by the alpha value, that precision falls even further. Ultimately, what may have begun as eight-bit color resolution, could end up being only one or two bits. For example, consider a simple scenario without any compression:
(0.8,0.5,0.3,0.1).

In the post-multiplied tuple above, the alpha value indicates a 10% opacity and contributions from each of the red, green and blue color channels. When multiplied by alpha, the intensity of the red channel goes from 0.8 to 0.08, which constitutes a loss in “color depth,” or fewer bits per color channel. Similarly, the green channel becomes 0.05, and the blue channel becomes 0.03. Essentially, bits of precision are “wasted” on representing the transparency, while the balance represents the color. It follows that precision loss is greater with higher transparency.

It is realized herein that correct-color texture filtering can be performed with the precision of post-multiplied alpha blending. It is realized herein that color data should be stored as post-multiplied data until fetched by a texture filtering unit or texture filtering shader. The texture filter can then unpack the post-multiplied data and convert to pre-multiplied, thereby applying the alpha channel. The texture filter should then carry out the intended filtering, employing the pre-multiplied tuples. It is further realized herein that the resulting, filtered, pre-multiplied color data may then be returned to post-multiplied format, and ultimately returned to memory or the requesting unit or process. In some cases, it is realized herein, returning the data to post-multiplied format is unnecessary and may be optionally left in pre-multiplied format. This gives users the flexibility use either pre-multiplied or post-multiplied texture blended data for a given process. It is also realized herein the conversion from post-multiplied tuples to pre-multiplied tuples is effectively achieved by multiplying the alpha channel by the RGB channels. Likewise, conversion from pre-multiplied tuples to post-multiplied tuples is effectively achieved by dividing the RGB channels by an alpha value. In certain embodiments the color-correct texture filter is implemented in hardware, in a texture filter unit. In other embodiments, the color-correct texture filter is implemented in software, possibly in a programmable shader. In still other embodiments, the principles taught herein are applied to color representations other than RGB, such as yellow, cyan, magenta (YCM).

Before describing various embodiments of the color-correct texture filter and method of texture filtering introduced herein, a computing system within which the texture filter or method maybe embodied or carried out will be described.

FIG. 1 is a block diagram of one embodiment of a computing system 100 in which one or more aspects of the invention may be implemented. The computing system 100 includes a system data bus 132, a central processing unit (CPU) 102, input devices 108, a system memory 104, a graphics processing subsystem 106, and display devices 110. In alternate embodiments, the CPU 102, portions of the graphics processing subsystem 106, the system data bus 132, or any combination thereof, may be integrated into a single processing unit. Further, the functionality of the graphics processing subsystem 106 may be included in a chipset or in some other type of special purpose processing unit or co-processor.

As shown, the system data bus 132 connects the CPU 102, the input devices 108, the system memory 104, and the graphics processing subsystem 106. In alternate embodiments, the system memory 100 may connect directly to the CPU 102. The CPU 102 receives user input from the input devices 108, executes programming instructions stored in the system memory 104, operates on data stored in the system memory 104, and configures the graphics processing subsystem 106 to perform specific tasks in the graphics pipeline. The system memory 104 typically includes dynamic random access memory (DRAM) employed to store programming instructions and data for processing by the CPU 102 and the graphics processing subsystem 106. The graphics processing subsystem 106 receives instructions transmitted by the CPU 102 and processes the instructions in order to render and display graphics images on the display devices 110.

As also shown, the system memory 104 includes an application program 112, an application programming interface (API) 114, and a graphics processing unit (GPU) driver 116. The application program 112 generates calls to the API 114 in order to produce a desired set of results, typically in the form of a sequence of graphics images. The application program 112 also transmits zero or more high-level shading programs to the API 114 for processing within the GPU driver 116. The high-level shading programs are typically source code text of high-level programming instructions that are designed to operate on one or more shading engines within the graphics processing subsystem 106. The API 114 functionality is typically implemented within the GPU driver 116. The GPU driver 116 is configured to translate the high-level shading programs into machine code shading programs that are typically optimized for a specific type of shading engine (e.g., vertex, geometry, or fragment).

The graphics processing subsystem 106 includes a graphics processing unit (GPU) 118, an on-chip GPU memory 122, an on-chip GPU data bus 136, a GPU local memory 120, and a GPU data bus 134. The GPU 118 is configured to communicate with the on-chip GPU memory 122 via the on-chip GPU data bus 136 and with the GPU local memory 120 via the GPU data bus 134. The GPU 118 may receive instructions transmitted by the CPU 102, process the instructions in order to render graphics data and images, and store these images in the GPU local memory 120. Subsequently, the GPU 118 may display certain graphics images stored in the GPU local memory 120 on the display devices 110.

The GPU 118 includes one or more streaming multiprocessors 124. Each of the streaming multiprocessors 124 is capable of executing a relatively large number of threads concurrently. Advantageously, each of the streaming multiprocessors 124 can be programmed to execute processing tasks relating to a wide variety of applications, including but not limited to linear and nonlinear data transforms, filtering of video and/or audio data, modeling operations (e.g., applying of physics to determine position, velocity, and other attributes of objects), and so on. Furthermore, each of the streaming multiprocessors 124 may be configured as a shading engine that includes one or more programmable shaders, each executing a machine code shading program (i.e. a thread) to perform image rendering operations. The GPU 118 may be provided with any amount of on-chip GPU memory 122 and GPU local memory 120, including none, and may employ on-chip GPU memory 122, GPU local memory 120, and system memory 104 in any combination for memory operations.

The on-chip GPU memory 122 is configured to include GPU programming code 128 and on-chip buffers 130. The GPU programming 128 may be transmitted from the GPU driver 116 to the on-chip GPU memory 122 via the system data bus 132. The GPU programming 128 may include a machine code vertex shading program, a machine code geometry shading program, a machine code fragment shading program, or any number of variations of each. The on-chip buffers 130 are typically employed to store shading data that requires fast access in order to reduce the latency of the shading engines in the graphics pipeline. Since the on-chip GPU memory 122 takes up valuable die area, it is relatively expensive.

The GPU local memory 120 typically includes less expensive off-chip dynamic random access memory (DRAM) and is also employed to store data and programming employed by the GPU 118. As shown, the GPU local memory 120 includes a frame buffer 126. The frame buffer 126 stores data for at least one two-dimensional surface that may be employed to drive the display devices 110. Furthermore, the frame buffer 126 may include more than one two-dimensional surface so that the GPU 118 can render to one two-dimensional surface while a second two-dimensional surface is employed to drive the display devices 110.

The display devices 110 are one or more output devices capable of emitting a visual image corresponding to an input data signal. For example, a display device may be built using a cathode ray tube (CRT) monitor, a liquid crystal display, or any other suitable display system. The input data signals to the display devices 110 are typically generated by scanning out the contents of one or more frames of image data that is stored in the frame buffer 126.

Having described a computing system within which the color-correct texture filter or method of texture filtering introduced herein may be embodied or carried out, various embodiments of the texture filter and method will be described.

FIG. 2 is a block diagram of one embodiment of a texture filter 200. Texture filter 200 includes an alpha blender 120, a filter 130 and a converter 140. Alpha blender 120 is configured to receive post-multiplied input RGBA data 110 and carry out alpha blending. Post-multiplied input RGBA data 110 includes a plurality of pixels that represent an image, each pixel having a color. The color for each pixel is represented as an RGBA tuple having red, green, blue and alpha channels. The values of the red, green and blue channels describe respective intensities. The value of the alpha channel describes the opacity of the color. Alpha blender 120 applies the alpha value by multiplying the alpha channel by each of the component color channels, the red, green and blue channels. This effectively converts the received post-multiplied color data to pre-multiplied color data, represented in tuples. The resulting tuples are considered color-correct.

Filter 130 is configured to fetch texels from a texture, blending neighboring texels together. Blending is accomplished by computing a weighted average of neighboring pixels, resulting in a smoothed or blurred effect. The resulting color data is in pre-multiplied format.

Converter 140 is configured to return the filtered pre-multiplied color data to post-multiplied format, thereby preserving the precision of the color. Conversion from pre- multiplied data to post-multiplied data is typically accomplished with a divider configured to divide the RGB color channels by an alpha value. Converter 140 then returns post-multiplied output RGBA data 150 to the requesting unit. In alternate embodiments, converter 140 can be employed according to a user option. When converter 140 is either omitted or not employed, the filtered pre-multiplied data is returned. The user option allows a user to determine which processes should use pre-multiplied data versus post-multiplied data. In certain embodiments the option is exercised at run-time through a user interface. In other embodiments, the option may be designed, or “hard-coded,” into a particular process or shader.

FIG. 3 is a flow diagram of one embodiment of a method of texture filtering. The method begins in a start step 310. In a receive step 320, pixel colors for a plurality of pixels are received from a post-multiplied source. The post-multiplied source provides the pixel colors in a post-multiplied tuple having red, green and blue component color channels, and an alpha channel. The post-multiplied pixel colors are converted from post-multiplied format to pre-multiplied format in a conversion step 330. The pre-multiplied pixel colors are in a pre-multiplied tuple having red, green and blue component color channels, and an alpha channel. By definition, the red, green and blue component color values of the pre-multiplied tuple are limited to a maximum value equal to the alpha value.

In a filter step 340, the plurality of pixels are filtered based on the pre-multiplied pixel colors. In certain embodiments, the pixel colors of neighboring pixels are blended together, and the weighted average is returned. The filtered pre-multiplied pixel colors are then returned to post-multiplied format in a return step 350. The results of the texture filtering process are returned or stored in memory in post-multiplied format to preserve the precision available in post- multiplied RGBA colors. The method then ends in a step 360.

Those skilled in the art to which this application relates will appreciate that other and further additions, deletions, substitutions and modifications may be made to the described embodiments.

What is claimed is:

1. A texture filter operable to process a plurality of pixels having respective pixel colors, comprising:
an alpha blender configured to receive a post-multiplied pixel color and convert to a pre-multiplied pixel color; and
a filter configured to apply texture filtering to said plurality of pixels based on pre-multiplied pixel colors.

2. The texture filter recited in claim 1 further comprising a converter configured to return resulting pixel colors as post-multiplied pixel colors.

3. The texture filter recited in claim 2 wherein said converter is operable to divide said red, green and blue components of said resulting pixel colors by respective alpha components, thereby arriving at said post-multiplied pixel colors.

4. The texture filter recited in claim 2 wherein said converter is employed according to a user option.

5. The texture filter recited in claim 1 wherein said post-multiplied pixel color is represented as a tuple having red, green and blue components and an alpha component.

6. The texture filter recited in claim 5 wherein said alpha component is a value ranging from zero to one and describes pixel color opacity.

7. The texture filter recited in claim 1 wherein said pre-multiplied pixel color is represented as a tuple having red, green and blue components and an alpha component.

8. The texture filter recited in claim 7 wherein said red, green and blue components have been pre-multiplied by said alpha component.

9. The texture filter recited in claim 1 wherein said filter is operable to blend said pre-multiplied pixel colors of adjacent pixels, of said plurality of pixels.

10. A method of texture filtering a plurality of pixels having respective pixel colors, comprising:
converting said respective pixel colors from post-multiplied format to pre-multiplied format;
filtering said plurality of pixels based on pre-multiplied pixel colors; and
returning filtered pre-multiplied pixel colors to post-multiplied format.

11. The method recited in claim 10 further comprising receiving said respective pixel colors from a post-multiplied source.

12. The method recited in claim 10 wherein said post-multiplied format includes red, green and blue components and an alpha component.

13. The method recited in claim 12 wherein said converting includes multiplying said red, green and blue components by said alpha component.

14. The method recited in claim 10 wherein said filtering includes computing a weighted color average of adjacent pixels of said plurality of pixels.

15. The method recited in claim 10 wherein said pre-multiplied format includes red, green and blue components and an alpha component.

16. The method recited in claim 15 wherein said returning includes dividing said red, green and blue components by said alpha component.

17. A graphics processing subsystem, comprising:
a memory coupled to a data bus and configured to store color and an alpha value as a post-multiplied tuple having red, green, blue and alpha components for a plurality of pixels; and
a processor coupled to said data bus and having a texture filtering unit configured to:
retrieve respective post-multiplied tuples for said plurality of pixels via said data bus,
apply alpha blending to said respective post-multiplied tuples,
employ alpha blended tuples to carry out texture filtering on said plurality of pixels,
compute respective new pre-multiplied tuples for said plurality of pixels, and
write said respective new pre-multiplied tuples in post-multiplied format to said memory via said data bus.

18. The graphics processing subsystem recited in claim 17 wherein said texture filtering unit is operable to apply color blending to said plurality of pixels.

19. The graphics processing subsystem recited in claim 17 wherein said memory is further configured to store said post-multiplied tuple as four eight-bit channels respectively representing said red, green, blue and alpha components.

20. The graphics processing subsystem recited in claim 17 wherein said processor is further configured to normalize an alpha channel to a decimal value ranging from zero to one.

21. The graphics processing subsystem recited in claim 17 wherein said processor includes a shading module operable to employ texture filtered post-multiplied colors to apply an effect to said plurality of pixels.

22. The graphics processing subsystem recited in claim 17 wherein said texture filtering unit comprises:
a multiplier for applying said alpha blending; and
a divider for returning said respective new pre-multiplied tuples to post-multiplied format.
